(19) United States
(12) Patent Application Publication
(10) Pub. No.: US 2011/0168550 A1
(43) Pub. Date: Jul. 14, 2011

(54) GRADED ELECTRODE TECHNOLOGIES FOR HIGH ENERGY LITHIUM-ION BATTERIES

(75) Inventors: Connie P. Wang, Mountain View, CA (US); Sergey D. Lopatin, Morgan Hill, CA (US); Robert Z. Bachrach, Burlingame, CA (US); Godfrey Sikha, Santa Clara, CA (US)

(73) Assignee: APPLIED MATERIALS, INC., Santa Clara, CA (US)

(21) Appl. No.: 12/953,143

(22) Filed: Nov. 23, 2010

Related U.S. Application Data
(60) Provisional application No. 61/294,628, filed on Jan. 13, 2010.

(51) Int. Cl. C25B 11/04; B05D 5/12; B05D 1/36; B05C 13/02; B05C 11/00

(52) U.S. Cl. 204/290.12; 204/290.01; 427/58; 427/126.3; 427/470; 118/58

(57) ABSTRACT

Embodiments described herein provide methods and systems for manufacturing faster charging, higher capacity energy storage devices that are smaller, lighter, and can be more cost effectively manufactured at a higher production rate. In one embodiment, a graded cathode structure is provided. The graded cathode structure comprises a conductive substrate, a first porous layer comprising a first cathodically active material having a first porosity formed on the conductive substrate, and a second porous layer comprising a second cathodically active material having a second porosity formed on the first porous layer. In certain embodiments, the first porosity is greater than the second porosity. In certain embodiments, the first porosity is less than the second porosity.

### CROSS-REFERENCE TO RELATED APPLICATIONS

This application claims benefit of U.S. provisional patent application Ser. No. 61/294,628 (Attorney Docket No. 14493L), filed Jan. 13, 2010, which is herein incorporated by reference in its entirety.

### BACKGROUND OF THE INVENTION

1. Field of the Invention

Embodiments of the present invention generally relate to lithium-ion battery cell components, and more specifically, to a method and a system for fabricating such components.

2. Description of the Related Art

High-capacity energy storage devices, such as lithium-ion (Li-ion) batteries, are used in a growing number of applications, including portable electronics, medical, transportation, grid-connected large energy storage, renewable energy storage, and uninterruptible power supply (UPS). In contemporary, secondary and rechargeable energy storage devices, the current collector component of the electrodes is generally made of a metal foil. Examples of materials for the positive current collector (the cathode) include aluminum, but stainless steel, and nickel may also be used. Examples of materials for the negative current collector (the anode) include copper (Cu), but stainless steel, and nickel (Ni) may also be used.

The active positive cathode electrode material of a Li-ion battery is typically selected from a wide range of lithium transition metal oxides. Examples include oxides with spinel structures (LiMn₂O₄ (LMO), LiNi_{0.5}Mn_{1.5}O₄ (LMNO), etc.), layered structures (LiCoO₂, nickel-manganese-cobalt (NMC), nickel-cobalt-aluminum (NCA), etc.), olivine structures (LiFePO₄, etc.), and combinations thereof. The particles are mixed with conductive particles, such as nano-carbon (carbon black, etc.) and graphite, and a binding agent. Such positive electrode material is considered to be a lithium-intercalation compound, in which the quantity of conductive material is in the range from 0.1% to 30% by weight. Next generation cathode materials are under active research with the goal of increasing capacity, i.e., >1 Li+ per redox center, or higher voltage (>4.3V).

Currently, anode material is generally carbon based, either graphite or hard carbon, with particle sizes around 5-15 um. Silicon (Si) and tin (Sn)-based active materials are currently being developed as next generation anode materials. Both have significantly higher capacity than carbon based electrodes. Li₁₅Si₄ has a capacity of about 3,580 mAh/g, whereas graphite has a capacity less than 372 mAh/g. Sn-based anodes can achieve capacities over 900 mAh/g which are much higher than next generation cathode materials can achieve. Thus, it is expected that cathodes will continue to be thicker than anodes.

Currently, the active materials only account for <50 wt % of the overall components of battery cells. The ability to manufacture thicker electrodes containing more active materials would significantly reduce the production costs for battery cells by reducing the percentage contribution from inactive elements. However, the thickness of electrodes is currently limited by both the utilization and the mechanical properties of the materials currently used.

Accordingly, there is a need in the art for faster charging, higher capacity energy storage devices that are smaller, lighter, and can be more cost effectively manufactured at a high production rate.

### SUMMARY OF THE INVENTION

Embodiments described herein provide methods and systems for manufacturing faster charging/discharging, higher capacity energy storage devices that are smaller, lighter, and can be more cost effectively manufactured at a higher production rate. In one embodiment, a graded cathode structure is provided. The graded cathode structure comprises a conductive substrate, a first porous layer comprising a first cathodically active material having a first porosity formed on the conductive substrate, and a second porous layer comprising a second cathodically active material having a second porosity formed on the first porous layer. In certain embodiments, the first porosity is greater than the second porosity. In certain embodiments, the first porosity is less than the second porosity.

In another embodiment, a method for forming a graded cathode structure is provided. The method comprises providing a conductive substrate, depositing a first porous layer comprising a first cathodically active material having a first porosity on the conductive substrate, and depositing a second porous layer comprising a second cathodically active material having a second porosity on the conductive substrate. In certain embodiments, the first porosity is greater than the second porosity. In certain embodiments, the first porosity is less than the second porosity.

In yet another embodiment, a graded cathode structure is provided. The graded cathode structure comprises a conductive substrate, a first layer comprising cathodically active particles having a first diameter formed on the conductive substrate, and a second layer comprising cathodically active particles having a second diameter formed on the first layer. In certain embodiments, the second diameter is greater than the first diameter. In certain embodiments, the second diameter is less than the first diameter. In certain embodiments, the particles are mirco-particles. In certain embodiments, the particles are nano-particles.

In yet another embodiment, a method for forming a graded cathode structure is provided. The method comprises providing a conductive substrate, depositing a first layer comprising cathodically active mircoparticles having a first diameter formed on the conductive substrate, and depositing a second layer comprising cathodically active microparticles having a second diameter formed on the first layer. In certain embodiments, the second diameter is greater than the first diameter. In certain embodiments, the second diameter is less than the first diameter.

In yet another embodiment, the first layer has different binder-conductive additive-active materials than the second layer. In yet another embodiment, the current collector comprises Al or Ni mesh, wires, or three-dimensional Al. In yet another embodiment, the three-dimensional Al is formed using a punch-through process, electrochemical etching or imprint lithography process.

In yet another embodiment, a substrate processing system for processing a vertically oriented flexible conductive substrate is provided. The substrate processing system comprises a first spray coating chamber configured to deposit cathodically active particles over the vertically oriented flexible conductive substrate, a drying chamber disposed adjacent the first spray coating chamber configured to expose the vertically oriented flexible conductive substrate to a drying process, a second spray coating chamber disposed adjacent to the drying chamber configured to deposit cathodically active particles over the vertically oriented flexible conductive substrate, a compression chamber disposed adjacent to the second spray coating chamber configured to expose the vertically oriented flexible conductive substrate to a calendaring process to compress the deposited particles to a desired net-density, and a substrate transfer mechanism configured to transfer the vertically oriented flexible conductive substrate among the chambers, wherein each of the chambers comprises a processing volume, a feed roll disposed out side the processing volume and configured to retain a portion of the vertically oriented flexible conductive substrate, and a take up roll disposed out side the processing volume and configured to retain a portion of the vertically oriented flexible conductive substrate, wherein the substrate transfer mechanism is configured to activate the feed rolls and the take up rolls to move the vertically oriented flexible conductive substrate in and out of each chamber, and hold the one or more flexible conductive substrates in the processing volume of each chamber. In certain embodiments, the substrate processing system further comprises a three-dimensional Al formation module for shaping the vertically oriented flexible conductive substrate into a three-dimensional vertically oriented conductive substrate positioned prior to the first spray coating chamber.

In another embodiment, an integrated separator is formed onto the electrode to reduce separator material cost and simplify manufacturing.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a schematic diagram of one embodiment of a Li-ion battery electrically coupled with a load according to embodiments described herein;

FIG. 1B is a schematic diagram of another embodiment of a Li-ion battery cell bi-layer electrically connected to a load according to embodiments described herein;

FIGS. 2A-2C are schematic cross-sectional views of one embodiment of a graded cathode electrode structure formed according to embodiments described herein;

FIG. 3 is a process flow chart summarizing one embodiment of a method for forming a graded cathode electrode structure according to embodiments described herein;

FIG. 4A is a perspective view of one embodiment of a porous conductive substrate prior to deposition of cathodically active material on the porous conductive substrate according to embodiments described herein;

FIG. 4B is a schematic cross-sectional view of one embodiment of a graded cathode electrode formed according to embodiments described herein;

FIGS. 5A-5C are schematic cross-sectional views of one embodiment of a graded cathode electrode structure formed according to embodiments described herein;

FIG. 6 is a process flow chart summarizing one embodiment of a method for forming a graded cathode electrode structure according to embodiments described herein;

FIG. 7 is a schematic cross-sectional view of one embodiment of a graded cathode electrode formed according to embodiments described herein;

FIGS. 8A-8C are schematic cross-sectional views of one embodiment of a cathode electrode structure formed according to embodiments described herein;

FIG. 9 is a process flow chart summarizing one embodiment of a method for forming a cathode electrode structure according to embodiments described herein;

FIGS. 10A-10H are schematic cross-sectional views of one embodiment of a cathode electrode structure formed according to embodiments described herein;

FIG. 11 schematically illustrates one embodiment of a vertical processing system according to embodiments described herein;

FIG. 12A is a plot illustrating a simulation demonstrating the effect of electrode thickness on electrode utilization;

FIG. 12B is a plot illustrating a simulation demonstrating the effect of graded porosity on specific energy; and

FIG. 13 is a plot depicting the theoretical energy density for various cathodically active materials that may be used in accordance with the embodiments described herein.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

Embodiments described herein contemplate methods and related apparatus for forming an electrochemical device, such as a battery or supercapacitor, and components thereof using thin-film deposition processes and other methods for forming the same. Certain embodiments described herein include the manufacturing of thick cathode electrodes having an increased capacity for active material by modifying various properties of the cathode electrodes. In certain embodiments, the cathode electrodes have graded properties, such as, porosity, conductivity, particle size, and combinations thereof that vary throughout the cathode electrode structure. In certain embodiments, it is desirable to modify the properties of the cathode electrode through the inclusion of additives such as conductive additives and/or binding agents. In certain embodiments, the graded properties of the cathode electrode may be further modified during the manufacturing process through the use of such techniques as calendaring, annealing, and various drying processes.

In certain embodiments, the cathode electrodes have a graded porosity such that the porosity varies throughout the structure of the cathode electrode. In certain embodiments, the graded porosity provides for a higher porosity adjacent to the current collector and a lower porosity as the distance from the current collector increases. The higher porosity adjacent to the current collector increases the active surface area of the electrode providing for higher power performance but yielding a lower voltage electrode whereas the lower porosity provides for a higher voltage electrode with slower power performance. In certain embodiments, the graded porosity provides for a lower porosity adjacent to the current collector and a higher porosity as the distance from the current collector increases.

In certain embodiments, the cathode electrodes have a graded particle size throughout the cathode electrode structure. In one embodiment, the smaller particles positioned adjacent to the current collector provide for higher power performance but yield a lower voltage electrode and the larger particles which are positioned at a greater distance from the current collector provide for a higher voltage electrode but decreased power performance.

In certain embodiments, the cathode electrodes comprise a multi-layer structure where the layers comprise cathodically active materials having different properties. In one embodiment, the active material deposited over the current collector provides higher power performance but a lower voltage electrode and the active material deposited at a distance from the current collector provides for a higher voltage electrode with slower power performance.

While the particular apparatus in which the embodiments described herein can be practiced is not limited, it is particularly beneficial to practice the embodiments on a web-based roll-to-roll system sold by Applied Materials, Inc., Santa Clara, Calif. Exemplary roll-to-roll and discrete substrate systems on which the embodiments described herein may be practiced are described herein and in further detail in commonly assigned U.S. patent application Ser. No. 12/620,788, (Attorney Docket No. APPM/012922/EES/AEP/ESONG), to Lopatin et al., now published as US 2010/0126849, titled APPARATUS AND METHOD FOR FORMING 3D NANOSTRUCTURE ELECTRODE FOR ELECTROCHEMICAL BATTERY AND CAPACITOR, and commonly assigned U.S. patent application Ser. No. 12/839,051, (Attorney Docket No. APPM/014080/AEP/LES/ESONG), filed Jul. 19, 2010, to Bachrach et al, titled COMPRRESSED POWDER 3D BATTERY ELECTRODE MANUFACTURING, both of which are herein incorporated by reference in their entirety.

The use of various types of substrates on which the materials described herein are formed is also contemplated. While the particular substrate on which certain embodiments described herein may be practiced is not limited, it is particularly beneficial to practice the embodiments on flexible conductive substrates, including for example, web-based substrates, panels and discrete sheets. The substrate may also be in the form of a foil, a film, or a thin plate. In certain embodiments where the substrate is a vertically oriented substrate, the vertically oriented substrate may be angled relative to a vertical plane. For example, in certain embodiments, the substrate may be slanted from between about 1 degree to about 20 degrees from the vertical plane. In certain embodiments where the substrate is a horizontally oriented substrate, the horizontally oriented substrate may be angled relative to a horizontal plane. For example, in certain embodiments, the substrate may be slanted from between about 1 degree to about 20 degrees from the horizontal plane. As used herein, the term “vertical” is defined as a major surface or deposition surface of the flexible conductive substrate being perpendicular relative to the horizon. As used herein, the term “horizontal” is defined as a major surface or deposition surface of the flexible conductive substrate being parallel relative to the horizon.

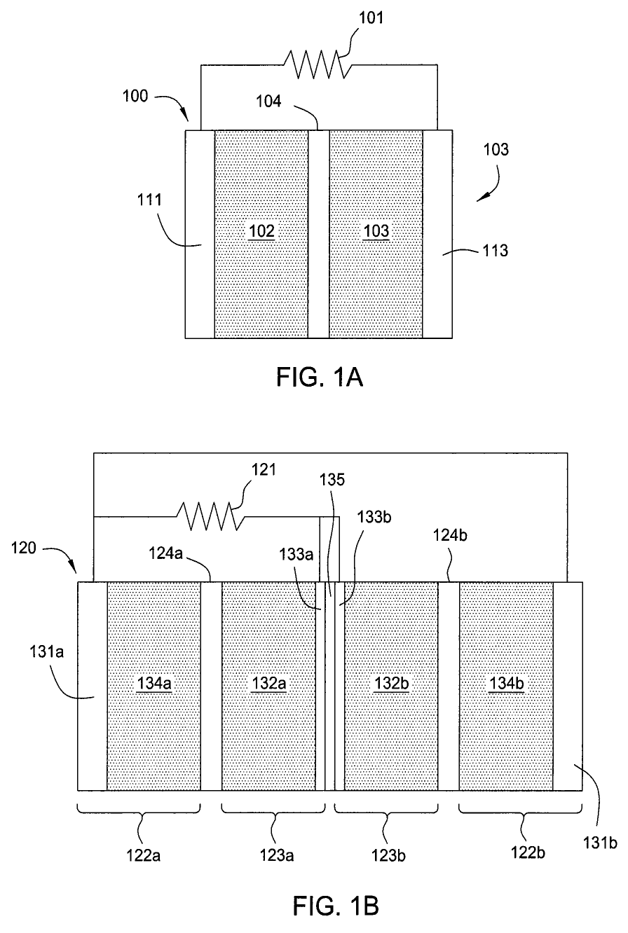

FIG. 1A is a schematic diagram of a Li-ion battery 100 electrically connected to a load 101, according to an embodiment described herein. The primary functional components of Li-ion battery 100 include an anode structure 102, a cathode structure 103, a separator layer 104, and an electrolyte (not shown) disposed within the region between the opposing current collectors 111 and 113. A variety of materials may be used as the electrolyte, such as a lithium salt in an organic solvent. Lithium salts may include, for example, LiPF₆, LiBF₄, or LiClO₄, and organic solvents may include, for example, ether and ethylene oxide. The electrolyte conducts lithium ions, acting as a carrier between the anode structure 102 and the cathode structure 103 when a battery passes an electric current through an external circuit. The electrolyte is contained in anode structure 102, cathode structure 103, and a fluid-permeable separator layer 104 in the region formed between the current collectors 111 and 113.

Anode structure 102 and cathode structure 103 each serve as a half-cell of Li-ion battery 100, and together form a complete working cell of Li-ion battery 100. Both the anode structure 102 and the cathode structure 103 comprise material into which and from which lithium ions can migrate. Anode structure 102 includes a current collector 111 and a conductive microstructure 110 that acts as an intercalation host material for retaining lithium ions. Similarly, cathode structure 103 includes a current collector 113 and an intercalation host material 112 such as a metal oxide for retaining lithium ions. Separator layer 104 may be a dielectric, porous, fluid-permeable layer that prevents direct electrical contact between the components in the anode structure 102 and the cathode structure 103. Methods of forming Li-ion battery 100, as well as the materials that make up the cathode structure 103 are described herein.

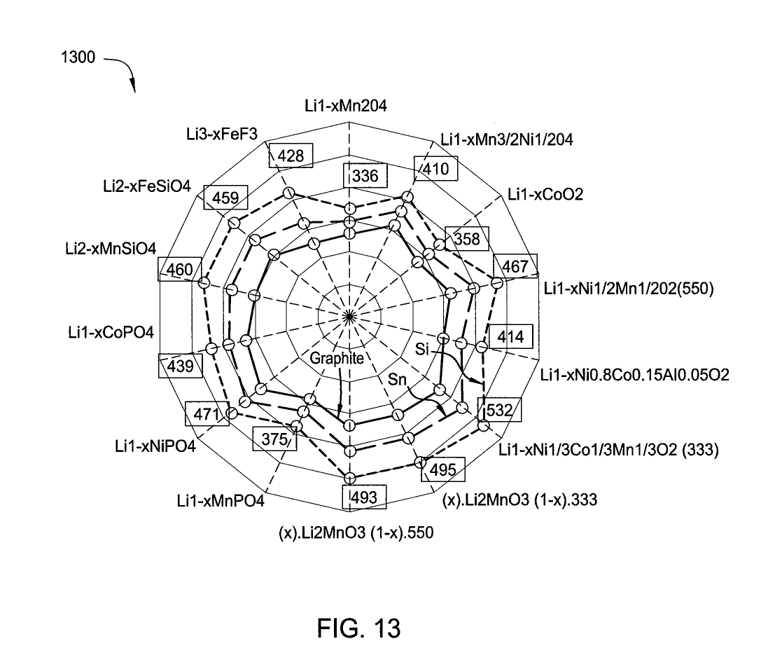

The electrolyte containing porous material on the cathode side of the Li-ion battery 100, or positive electrode, may comprise a lithium-containing metal oxide, such as lithium cobalt dioxide (LiCoO₂) or lithium manganese dioxide (LiMnO₂). The electrolyte containing porous material may be made from a layered oxide, such as lithium cobalt oxide, an olivine, such as lithium iron phosphate, or a spinel, such as lithium manganese oxide. In non-lithium embodiments, an exemplary cathode may be made from TiS₂ (titanium disulfide). Exemplary lithium-containing oxides may be layered, such as lithium cobalt oxide (LiCoO₂), or mixed metal oxides, such as LiNiₓCo₁₋₂ₓMnO₂, LiNi_{0.5}Mn_{1.5}O₄, Li(Ni_{0.8}Co_{0.15}Al_{0.05})O₂, LiMn₂O₄, and LiNiO₂. Exemplary phosphates may be iron olivine (LiFePO₄) and it is variants (such as LiFe₁₋ₓMgPO₄), LiMoPO₄, LiCoPO₄, LiNiPO₄, Li₃V₂(PO₄)₃, LiVOPO₄, LiMP₂O₇, or LiFe_{1.5}P₂O₇. Exemplary fluorophosphates may be LiVPO₄F, LiAlPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃. Other exemplary electrolyte containing porous materials include Li₃FeF₃, Li₂MnO₃.NMC, and the porous materials shown in FIG. 13.

The electrolyte containing porous material on the anode side of the Li-ion battery 100, or negative electrode, may be made from materials described above, for example, graphitic particles dispersed in a polymer matrix and/or various fine powders, for example, micro-scale or nano-scale sized powders. Additionally, microbeads of silicon, tin, or lithium titanate (Li₄Ti₅O₁₂) may be used with, or instead of, graphitic microbeads to provide the conductive core anode material. The electrolyte containing porous material on the cathode side of the Li-ion battery 100, or positive electrode, may be made according to the embodiments described herein.

FIG. 1B is a schematic diagram of a single sided Li-ion battery cell bi-layer 120 with anode structures 122a, 122b electrically connected to a load 121, according to one embodiment described herein. The single sided Li-ion battery cell bi-layer 120 functions similarly to the Li-ion battery 100 depicted in FIG. 1A. The primary functional components of Li-ion battery cell bi-layer 120 include anode structures 122a, 122b, cathode structures 123a, 123b, separator layers 124a, 124b, and an electrolyte (not shown) disposed within the region between the current collectors 131a, 131b, 133a, and 133b. The Li-ion battery cell 120 may be hermetically sealed with electrolyte in a suitable package with leads for the current collectors 131a, 131b, 133a, and 133b. The anode structures 122a, 122b, cathode structures 123a, 123b, and fluid-permeable separator layers 124a, 124b are immersed in the electrolyte in the region formed between the current collectors 131a and 133a and the region formed between the current collectors 131b and 133b. An insulator layer 135 may be disposed between current collector 133a and current collector 133b.

Anode structures 122a, 122b and cathode structures 123a, 123b each may serve as a half-cell of Li-ion battery cell 120, and together form a complete working bi-layer cell of Li-ion battery 120. Anode structures 122a, 122b each include a metal current collector 131a, 131b and a first electrolyte containing material 134a, 134b. Similarly, cathode structures 123a, 123b include a current collector 133a and 133b respectively and a second electrolyte containing material 132a, 132b, such as a metal oxide, for retaining lithium ions. The current collectors 131a, 131b, 133a, and 133b may be made of electrically conductive materials such as metals and metal alloys. In some cases, a separator layer 124a, 124b, which is an insulating, porous, fluid-permeable layer, for example, a dielectric layer, may be used to prevent direct electrical contact between the components in the anode structures 122a, 122b and the cathode structures 123a, 123b. It should also be understood that the embodiments described herein are not limited to Li-ion cell structures shown in FIG. 1A and FIG. 1B. It should also be understood, that the anode and cathode structures may be connected either in series or in parallel.

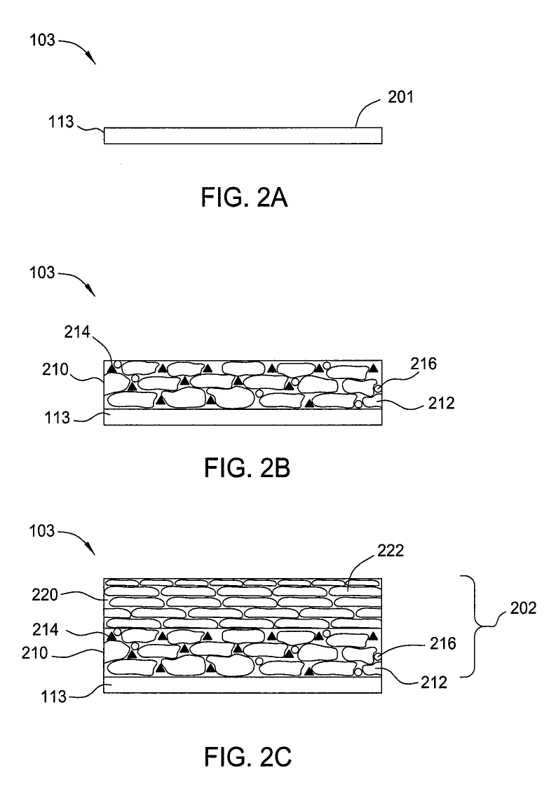

FIGS. 2A-2C are schematic cross-sectional views of one embodiment of a cathode electrode structure 103 formed according to embodiments described herein. In FIG. 2A, current collector 113 is schematically illustrated prior to the deposition of the graded porous structure 202 on the current collector 113. In one embodiment, the current collector 113 is a conductive substrate (e.g., metallic foil, sheet, or plate). In one embodiment, the current collector 113 is a conductive substrate with an insulating coating disposed thereon. In one embodiment, the current collector 113 may include a relatively thin conductive layer disposed on a host substrate comprising one or more conductive materials, such as a metal, plastic, graphite, polymers, carbon-containing polymer, composites, or other suitable materials. Examples of metals that current collector 113 may be comprised of include aluminum (Al), copper (Cu), zinc (Zn), nickel (Ni), cobalt (Co), tin (Sn), silicon (Si), manganese (Mn), magnesium (Mg), alloys thereof, and combinations thereof. In one embodiment, the current collector 113 is perforated.

Alternatively, current collector 113 may comprise a host substrate that is non-conductive, such as a glass, silicon, and plastic or polymeric substrate that has an electrically conductive layer formed thereon by means known in the art, including physical vapor deposition (PVD), electrochemical plating, electroless plating, and the like. In one embodiment, current collector 113 is formed out of a flexible host substrate. The flexible host substrate may be a lightweight and inexpensive plastic material, such as polyethylene, polypropylene or other suitable plastic or polymeric material, with a conductive layer formed thereon. In one embodiment, the conductive layer is between about 10 and 15 microns thick in order to minimize resistive loss. Materials suitable for use as such a flexible substrate include a polyimide (e.g., KAPTON™ by DuPont Corporation), polyethyleneterephthalate (PET), polyacrylates, polycarbonate, silicone, epoxy resins, silicone-functionalized epoxy resins, polyester (e.g., MYLAR™ by E.I. du Pont de Nemours & Co.), APICAL AV manufactured by Kanegaftigi Chemical Industry Company, UPILEX manufactured by UBE Industries, Ltd.; polyethersulfones (PES) manufactured by Sumitomo, a polyetherimide (e.g., ULTEM by General Electric Company), and polyethylenenaphthalene (PEN). Alternately, the flexible substrate may be constructed from a relatively thin glass that is reinforced with a polymeric coating.

In one embodiment, the current collector 113 is treated prior to formation of the graded porous structure 202 to improve contact resistance and adhesion of the electrode to the current collector 113.

As shown in FIG. 2B, a first porous layer 210 comprising a first cathodically active material 212 having a first porosity is formed over a surface 201 of the current collector 113. In one embodiment, the first porous layer 210 has a thickness between about 10 μm to about 150 μm. In one embodiment, the first porous layer 210 has a thickness between about 50 μm to about 100 μm. In embodiments where the current collector 113 is a porous structure, the first porous layer 210 may be deposited within the pores of the current collector 113.

In one embodiment, the first cathodically active material 212 is in the form of particles. In one embodiment, the particles are nano-scale particles. In one embodiment, the nano-scale particles have a diameter between about 1 nm and about 100 nm. In one embodiment, the particles are micro-scale particles. In one embodiment, the particles of the powder include aggregated micro-scale particles. In one embodiment, the micro-scale particles have a diameter between about 2 μm and about 15 μm. In certain embodiments it is desirable to select a particle size that maintains the packing density of the particles while maintaining a reduced surface area in order to avoid unwanted side reactions which may occur at higher voltages. In certain embodiments, the particle size may depend on the type of cathodically active material used. In one embodiment, the cathodically active material 212 is selected from the group comprising: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof.

In certain embodiments, the first porous layer 210 further comprises conductive additives 214 for providing a conductive path between the highly resistive particles of the first cathodically active material 212. In one embodiment, the conductive additives 214 may be selected from the group comprising: graphite, graphene hard carbon, carbon black, carbon coated silicon, tin particles, tin oxide, silicon carbide, silicon (amorphous or crystalline), silicon alloys, doped silicon, lithium titanate, composites thereof, and combinations thereof.

In certain embodiments, the first porous layer 210 further comprises a binding agent 216. In certain embodiments, the binding agent 216 coats the surface of the particles of the first cathodically active material 212. In one embodiment, the binding agent 216 is a carbon containing polymer having a low molecular weight provided at a ratio of less than about 100 polymer molecules per particle. The low molecular weight polymer may have a number average molecular weight of less than about 10,000 to promote adhesion of the particles to the substrate. In one embodiment, the binding agent 216 is selected from the group comprising: polyvinylidene difluoride (PVDF) styrene-butadiene rubber (SBR), carboxymethyl cellulose (CMC), water soluble binders, and combinations thereof. In one embodiment, N-methyl-2-pyrrolidone (NMP) is used as a carrier for the binding agent.

As shown in FIG. 2C, a second porous layer 220 comprising a second cathodically active material 222 having a second porosity is formed over the first porous layer 210. In one embodiment, the second porous layer 220 has a thickness between about 10 μm to about 150 μm. In one embodiment, the second porous layer 220 has a thickness between about 50 μm to about 100 μm.

In one embodiment, the second cathodically active material 222 is in the form of particles. In one embodiment, the particles are nano-scale particles. In one embodiment, the nano-scale particles have a diameter between about 1 nm and about 100 nm. In one embodiment, the particles are micro-scale particles. In one embodiment, the particles of the powder include aggregated micro-scale particles. In one embodiment, the micro-scale particles have a diameter between about 2 μm and about 15 μm. In one embodiment, the second cathodically active material 222 is selected from the group comprising: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₄, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof. In one embodiment, the first cathodically active material 212 and the second cathodically active material 222 are identical materials. In one embodiment, the first cathodically active material 212 and the second cathodically active material 222 are different materials selected to vary the properties of each layer.

In certain embodiments, the first porosity of the first porous layer 210 is greater than the second porosity of the second porous layer 220. In certain embodiments, the first layer has a porosity or “first porosity” of at least 40%, 45%, 50%, 55%, 60%, or 65% as compared to a solid film formed from the same material. In certain embodiments, the first layer has a first porosity up to 45%, 50%, 55%, 60%, 65%, or 70% as compared to a solid film formed from the same material. In certain embodiments, the second layer has a porosity or “second porosity” of at least 20%, 25%, 30%, or 35% as compared to a solid film formed from the same material. In certain embodiments, the second layer has a porosity up to 25%, 30%, 35%, or 40% as compared to a solid film formed from the same material. In one embodiment, the first porosity is between about 40% and about 70% as compared to a solid film formed from the same material and the second porosity is between about 20% and about 40% as compared to a solid film formed from the same material.

In certain embodiments, the first porosity of the first porous layer 210 is less than the second porosity of the second porous layer 220. In certain embodiments, the first layer has a porosity or “first porosity” of at least 20%, 25%, 30%, or 35% as compared to a solid film formed from the same material. In certain embodiments, the first layer has a porosity up to 25%, 30%, 35%, or 40% as compared to a solid film formed from the same material. In certain embodiments, the second layer has a porosity or “second porosity” of at least 40%, 45%, 50%, 55%, 60%, or 65% as compared to a solid film formed from the same material. In certain embodiments, the second layer has a second porosity up to 45%, 50%, 55%, 60%, 65%, or 70% as compared to a solid film formed from the same material. In one embodiment, the second porosity is between about 40% and about 70% as compared to a solid film formed from the same material and the first porosity is between about 20% and about 40% as compared to a solid film formed from the same material. In one embodiment, the second porosity is between about 40% and about 70% as compared to a solid film formed from the same material and the first porosity is between about 20% and about 35% as compared to a solid film formed from the same material.

In certain embodiments, at least one of the first porous layer 210 and the second porous layer 220 is exposed to a compression process such as a calendaring process to increase the density of and decrease the porosity of the first porous layer 210 and/or the second porous layer 220. Although discussed as a two layer structure, it should be understood that any number of layers comprising different materials, particle sizes, and/or density may be used to form the porous cathode structure described herein. For example, in certain embodiments, the graded cathode structure comprises three of more layers with the porosity of each layer increasing relative to the previously deposited layer as the graded cathode structure extends from the current collector toward the separator. In certain embodiments, the graded cathode structure comprises three of more layers with the porosity of each layer decreasing relative to the previously deposited layer as the graded cathode structure extends from the current collector toward the separator. In certain embodiments where a dual sided electrode is formed, each porous layer may be simultaneously deposited on opposing sides of the substrate using a dual-sided deposition process.

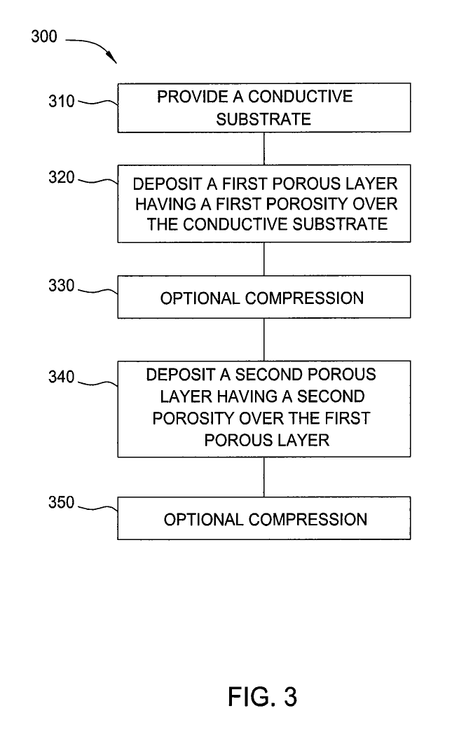

FIG. 3 is a process flow chart summarizing one embodiment of a method 300 for forming a graded cathode structure similar to cathode structure 103 as illustrated in FIGS. 1A, 1B and 2A-2C, according to embodiments described herein. In block 310, a substrate substantially similar to current collector 113 in FIG. 1 is provided. As detailed above, the substrate may be a conductive substrate, such as metallic foil, or a non-conductive substrate that has an electrically conductive layer formed thereon, such as a flexible polymer or plastic having a metallic coating.

In block 320, a first porous layer similar to first porous layer 210 having a first porosity is deposited over the conductive substrate. The first porous layer may be formed by depositing particles of a first cathodically active material as disclosed herein. In certain embodiments, it may be desirable to deposit conductive additives and/or a binding agent in conjunction with the first cathodically active material. In certain embodiments, the first cathodically active material may be pre-mixed with particles of conductive additives and/or binding agents prior to deposition on the conductive substrate. In certain embodiments, the binding agent coats the particles of first cathodically active material. In certain embodiments, the first cathodically active material may be concurrently deposited along with the particles of the conductive additives and/or binding agents from separate sources over the conductive substrate.

In one embodiment, the particles may be applied by particle application techniques including but not limited to sifting techniques, electrostatic spraying techniques, thermal or flame spraying techniques, fluidized bed coating techniques, roll coating techniques, slit coating, and combinations thereof, all of which are known to those skilled in the art. One exemplary process is a two-pass deposition process wherein a first pass deposits particles over the conductive substrate using a spray coating method followed by a second pass over the substrate to deposit additional particles via a slit coating process. Another exemplary two-pass deposition process involves depositing particles over the conductive substrate using a slit coating process followed by an electrostatic spraying process to further densify the structure.

In certain embodiments, electrostatic spraying methods are used to deposit particles or powder over the conductive substrate. Electrostatic spraying charges the powder particles and then sprays them toward the area to be coated, such as the conductive substrate, with an opposite and attractive electric charge. Since the charged powders in the spray stream are attracted toward the area to be coated, the electrostatic process helps minimize overspray and waste.

In certain embodiments, fluidized bed coating methods may be used to insert cathodically active particles over and/or into the conductive substrate. In fluidized bed systems, air is blown up through a porous bed or screen to suspend the powder thereby forming a fluidized bed. The item to be coated is inserted into the fluidized bed allowing the particles to stick onto the exposed surfaces. Coating particles in a fluidized bed can also be charged for the application of thicker coatings.

In certain embodiments, thermal, plasma, or flame spraying techniques may be used to deposit the cathodically active particles over the conductive substrate. Thermal spraying techniques are coating processes in which melted (or heated) materials are sprayed onto a surface. The “feedstock” (coating precursor) is heated by electrical (e.g. plasma or arc) or chemical means (e.g. combustion flame). Coating materials available for thermal spraying include metals, alloys, ceramics, plastics and composites. The coating materials are fed in powder form; heated to a molten or semi-molten state and accelerated towards the substrate in the form of micrometer-size particles. Combustion or electrical arc discharge is usually used as the source of energy for thermal spraying. Exemplary thermal spraying techniques and apparatus are described in commonly assigned U.S. patent application Ser. No. 12/862,265, Attorney Docket No. APPM/014344.02/AEP/LES/ESONG), filed Aug. 24, 2010, to Shang et al., titled IN-SITU DEPOSITION OF BATTERY ACTIVE LITHIUM MATERIALS BY THERMAL SPRAYING, which is herein incorporated by reference in its entirety. Exemplary plasma spraying techniques and apparatus are described in commonly assigned U.S. patent application Ser. No. 12/862,244, Attorney Docket No. APPM/014344/AEP/LES/ESONG), filed Aug. 24, 2010, to Shang et al., titled IN-SITU DEPOSITION OF BATTERY ACTIVE LITHIUM MATERIALS BY PLASMA SPRAYING, which is herein incorporated by reference in its entirety.

In certain embodiments, roll coating techniques may be used to deposit the cathodically active particles over the conductive substrate. In one embodiment, the coating is made by forming a slurry of the cathodically active material in a solvent, such as, N-methyl pyrrolidone (NMP). In one embodiment, the coating further comprises binding agents and conductive additives. After application of the coating, the solvent may be removed using the drying techniques disclosed herein. In certain embodiments, the drying process may be used to encourage close settling of the particles.

In certain embodiments, where a dual-sided electrode is formed, the first porous layer may be simultaneously deposited on opposing sides of the substrate using a dual-sided deposition process. For example, a dual-sided electrostatic spraying process which uses opposing spray applicators to deposit cathodically active material on opposing sides of the substrate. In certain embodiments, where a dual-sided electrode is formed, the first layer may be formed using a two-pass process where the first layer is deposited over a first side of the current collector during a first pass and the first layer is deposited over an opposing side of a substrate during a second pass.

In block 330, the first porous layer may be exposed to an optional compression process. After the particles are deposited over the conductive substrate, the particles may be compressed using compression techniques, for example, a calendaring process, to achieve a desired net density of compacted particles while planarizing the surface of the layer. In certain embodiments, it is desirable to perform a calendaring process after deposition of the first porous layer in order to increase the net density of the first porous layer.

The first porous layer may be exposed to an optional drying process to remove any remaining solvents from the deposition process. The optional drying process may comprise, but is not limited to, drying processes such as an air drying process, for example, exposing the porous layer to heated nitrogen, an infrared drying process, a marangoni drying process, and an annealing process, for example, a rapid thermal annealing process.

In block 340, a second porous layer similar to second porous layer 220 having a second porosity is deposited over the first porous layer 210. The second porous layer may be formed by depositing particles of a second cathodically active material as disclosed herein. In certain embodiments, it may be desirable to deposit conductive additives and/or a binding agent in conjunction with the second cathodically active material. In certain embodiments, the second cathodically active material may be pre-mixed with particles of conductive additives and/or binding agents prior to deposition on the first porous layer. In certain embodiments, the second cathodically active material may be concurrently deposited along with the particles of the conductive additives and/or binding agents from separate sources over the conductive substrate. In certain embodiments, the particles may be deposited using the deposition techniques discussed in reference to block 320.

In certain embodiments, where a dual-sided electrode is formed, the second porous layer may be simultaneously deposited on opposing sides of the substrate using a dual-sided deposition process as discussed with reference to block 320.

In one embodiment, the first cathodically active material is identical to the second cathodically active material. In one embodiment, the first cathodically active material is a different material than the second cathodically active material.

In one embodiment, the particles of the first cathodically active material are a different size than the particles of the second cathodically active material. In one embodiment, the particles of the first cathodically active material and the second cathodically active material are approximately the same size.

In block 350, the second porous layer may be exposed to an optional compression process. After the particles are deposited over the conductive substrate, the particles may be compressed using compression techniques, for example, a calendaring process, to achieve a desired net density of compacted particles while planarizing the surface of the layer. In certain embodiments, it is desirable to perform a calendaring process after deposition of the second porous layer in order to increase the net density of the second porous layer relative to the first porous layer. In certain embodiments, a drying process similar to the process of block 330 is performed.

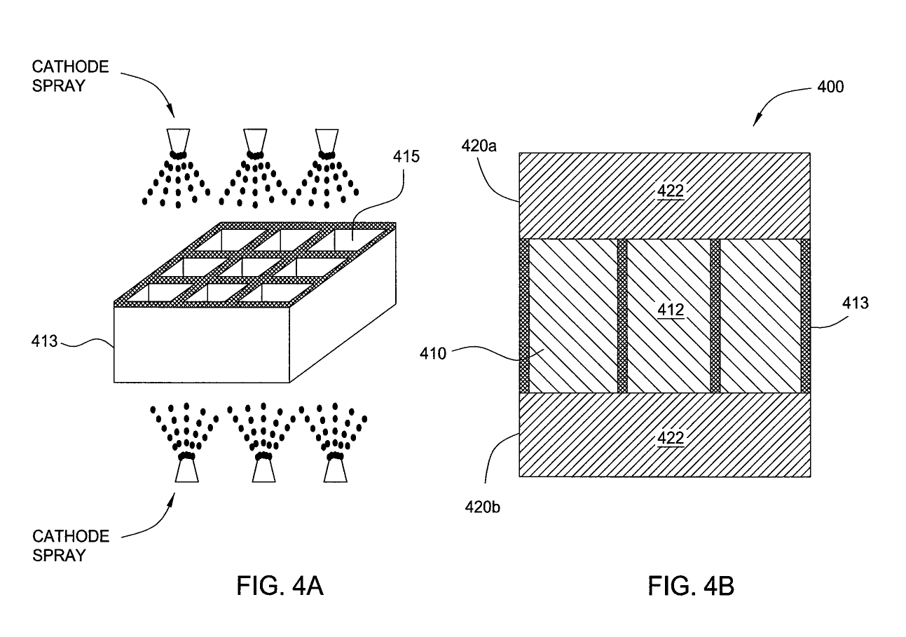

FIG. 4A is a perspective view of one embodiment of a porous conductive substrate 413 prior to deposition of cathodically active material into and over the porous conductive substrate according to embodiments described herein. FIG. 4B is a schematic cross-sectional view of one embodiment of a graded cathode electrode 400 formed according to embodiments described herein. The graded cathode electrode 400 is similar to the cathode electrode 103 except that the graded cathode electrode 400 is formed using a porous conductive current collector 413, the first cathodically active material 412 is deposited within the pores of the porous conductive current collector, and the graded cathode electrode 400 is a two-sided cathode electrode with a shared three-dimensional porous current collector 413. It should be understood that although the graded cathode electrode 400 is depicted as a two-sided electrode, the graded cathode electrode 400 may also be a single sided electrode.

The graded cathode electrode 400 may be formed using processes similar to the process depicted in FIG. 3 except that a first porous layer 410, similar to porous layer 210, is deposited within the pores of the porous conductive substrate 413 using a dual-sided deposition process and second porous layers 420a, 420b are formed on opposing sides of the porous conductive current collector 413 using a dual-sided deposition process, for example, a two-sided spray coating process.

The substrate or current collector 413 is similar to current collector 113. In one embodiment, the substrate or current collector 413 is an aluminum substrate or an aluminum alloy substrate. In one embodiment, the current collector 413 is perforated or porous three dimensional structure having a plurality of pores 415. In one embodiment, the three-dimensional structure may be formed using, for example, an imprint lithography process or a patterned punch through process. In one embodiment, the three-dimensional structure comprises a wire mesh structure comprising a material selected from aluminum and alloys thereof. In one embodiment, the wire mesh structure has a wire diameter between about 0.050 micrometers and about 10 micrometers. In one embodiment, the wire mesh structure has an aperture between about 10 micrometers and about 100 micrometers, for example about 90 micrometers. In certain embodiments, it may be desirable to use the wire mesh structure as the three-dimensional cathode structure since its formation does not require imprinting or etching.

In one embodiment, the porous current collector 413 is a three dimensional structure having a porosity of from about 50% to about 90%. In one embodiment, the current collector 413 is a three dimensional structure having a porosity of from about 70% to about 85%, for example, about 81%.

As shown in FIG. 4B, a first porous layer 410 comprising a first cathodically active material 412 having a first porosity is formed within the pores 415 of the porous current collector 413. In one embodiment, the first cathodically active material 412 is vertically sprayed into the pores of the porous current collector 413 using a single or multi-step deposition process. In one embodiment, the first porous layer 410 has a thickness between about 50 μm to about 200 μm, for example, about 100 μm. In certain embodiments, the first porous layer 410 has a porosity greater than the porosity of second porous layers 420a, 420b. In certain embodiments, the first porous layer 410 has a porosity less than the porosity of second porous layers 420a, 420b.

As shown in FIG. 4B, second porous layers 420a, 420b comprising a second cathodically active material 422 having a second porosity are formed over the first porous layer 410. In one embodiment, second porous layers 420a, 420b have a thickness between about 50 μm to about 100 μm. In one embodiment, second porous layers 420a, 420b have a porosity less than that of the first porous layer 410. In one embodiment, second porous layers 420a, 420b have a porosity greater than that of the first porous layer 410. In one embodiment, as initially deposited, the porosity of the first porous layer 410 and second porous layers 420a and 420b are substantially identical, however, after exposing the second porous layers to the optional compression process described in block 350, the porosity of second porous layers 420a, 420b is reduced relative to the porosity of the first porous layer 410. In embodiments where the optional compression process is a calendaring process, the overburden portion (e.g. the second porous layers 420a, 420b) are more effectively densified while the first porous layer 410 within the three-dimensional structure is less densified due to the typical mechanical behavior of the composite structure. In certain embodiments where the first porous layer 410 has greater density than the second porous layers 420a, 420b the first porous layer may be exposed to an optional compression process similar to the compression process described in block 330. In certain embodiments, the second porous layers 420a, 420b have a porosity between about 40% and about 50% as compared to a solid film formed from the same material and the first porous layer 410 has a porosity between about 30% and about 35% as compared to a solid film formed from the same material.

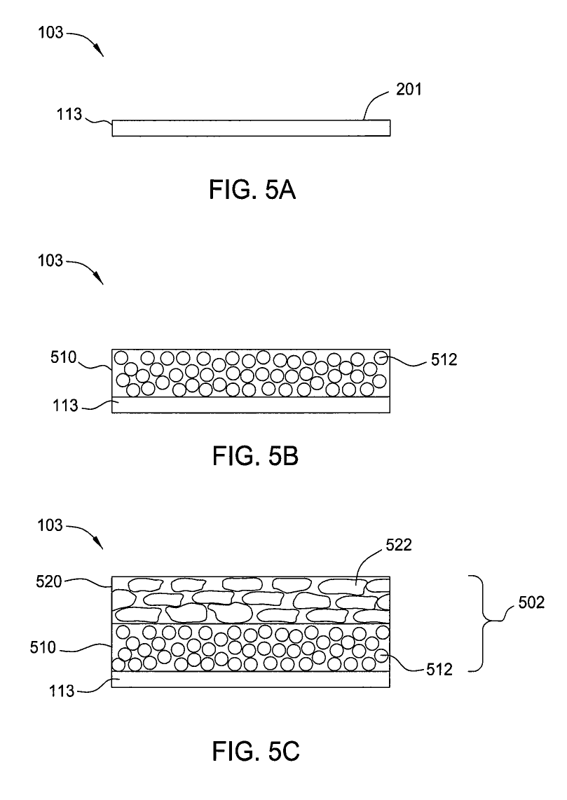

FIGS. 5A-5C are schematic cross-sectional views of one embodiment of a graded cathode electrode structure 103 having a particle size gradient formed according to embodiments described herein. In FIG. 5A, current collector 113 is schematically illustrated prior to the deposition of the graded particle structure 502 on the current collector 113.

As shown in FIG. 5B, a first layer 510 having first cathodically active particles 512 having a first diameter is formed over a surface 201 of the current collector 113. In one embodiment, the first layer 510 has a thickness between about 10 μm to about 150 μm. In one embodiment, the first layer 510 has a thickness between about 50 μm to about 100 μm. In one embodiment, the particles are nano-scale particles. In one embodiment, the nano-scale particles have a diameter between about 1 nm and about 100 nm. In one embodiment, the particles are micro-scale particles. In one embodiment, the particles of the powder include aggregated micro-scale particles. In one embodiment, the micro-scale particles have a diameter between about 2 μm and about 15 μm. In one embodiment, the first diameter is less than 10 μm. In one embodiment, the first diameter is about 5 μm.

As discussed herein, in certain embodiments, it may be desirable to deposit conductive additives and/or a binding agent in conjunction with the first cathodically active particles.

As shown in FIG. 5C, a second layer 520 having second cathodically active particles 522 having a second diameter is formed over the first layer 510. In one embodiment, the second layer 520 has a thickness between about 10 μm to about 150 μm. In one embodiment, the second layer 520 has a thickness between about 50 μm to about 100 μm. In one embodiment, the second cathodically active particles 522 have a second diameter greater than five times the particle size of the particles of the first layer. In one embodiment, the particles are nano-scale particles. In one embodiment, the nano-scale particles have a diameter between about 1 nm and about 100 nm. In one embodiment, the particles are micro-scale particles. In one embodiment, the particles of the powder include aggregated micro-scale particles. In one embodiment, the micro-scale particles have a diameter between about 2 μm and about 75 μm. In one embodiment, the second diameter is between about 5 μm and about 50 μm. In one embodiment, the second diameter is about 15 μm. In certain embodiments, the second diameter of the cathodically active particles 522 is greater than the first diameter of cathodically active particles 512. In certain embodiments, the second diameter of the cathodically active particles 522 is less than the first diameter of cathodically active particles 512.

In certain embodiments where the particles are micrometer sized particles, for example, layered oxides and spinels, the second cathodically active particles have a particle diameter greater than five times the particle size of the particles of the first layer so the solid state diffusion time is noticeably different. In other embodiments where cathode materials are nano-sized, such as, for example, LiFePO₄, Li₂MnSiO₄, the cathodically active particles of the second layer may be greater than five times the particle size of the particles of the first layer. Additional diffusion enhancement can come from surface treatment.

In one embodiment, the first layer 510 has a porosity greater than a second porosity of the second layer 520. In one embodiment, the first porosity is between about 40% and about 50% as compared to a solid film formed from the same material and the second porosity is between about 30% and about 40% as compared to a solid film formed from the same material. In certain embodiments, the first layer 510 has a porosity less than the porosity of the second layer 520. In certain embodiments, the first porosity is between about 30% and about 35% as compared to a solid film formed from the same material and the second porosity is between about 40% and about 50% as compared to a solid film formed from the same material.

In certain embodiments, the second layer 520 is exposed to a compression process such as a calendaring process to modify the shape of the particles and increase the packing density of the particles in the second layer. In certain embodiments where the first layer 510 has greater density than the second layer 520, the first layer may be exposed to an optional compression process similar to the compression processes described herein.

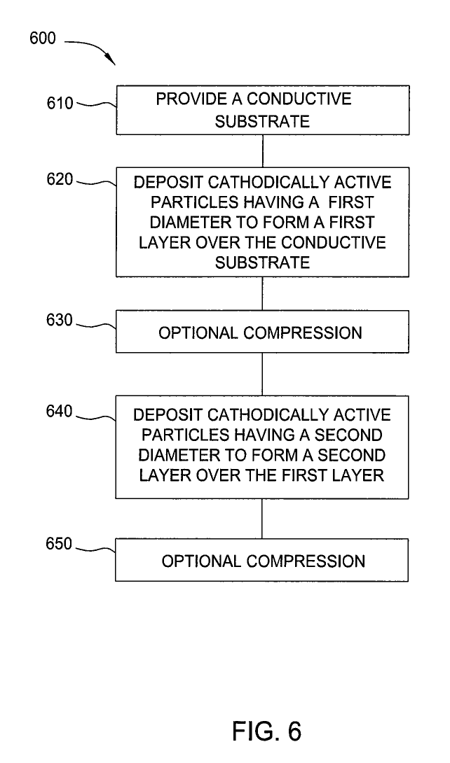

FIG. 6 is a process flow chart summarizing one embodiment of a method 600 for forming a graded cathode structure having a particle size gradient similar to cathode structure 103 as illustrated in FIGS. 1 and 5A-5C, according to embodiments described herein. In block 610, a substrate substantially similar to current collector 113 in FIG. 1 is provided. As detailed above, the substrate may be a conductive substrate, such as metallic foil, or a non-conductive substrate that has an electrically conductive layer formed thereon, such as a flexible polymer or plastic having a metallic coating.

In block 620, a first layer similar to first layer 510 comprising first cathodically active particles having a first diameter is deposited over the conductive substrate. The first layer may be formed by depositing particles of a cathodically active material as disclosed herein. In certain embodiments, it may be desirable to deposit conductive additives and/or a binding agent in conjunction with the cathodically active material as disclosed herein.

In block 630, the first layer may be exposed to an optional compression process. After the particles are deposited over the conductive substrate, the particles may be compressed using compression techniques, for example, a calendaring process, to achieve a desired net density of compacted particles while planarizing the surface of the first layer.

The first layer may be exposed to an optional drying process to remove any remaining solvents from the deposition process. The drying process may be tailored to adjust the thickness of the first layer. The optional drying process may comprise, but is not limited to, drying processes such as an air drying process, for example, exposing the porous layer to heated nitrogen, an infrared drying process, a marangoni drying process, and an annealing process, for example, a rapid thermal annealing process.

In block 640, a second layer similar to second layer 520 comprising second cathodically active particles having a second diameter is deposited over the first layer. The second layer may be formed by depositing particles of a cathodically active material as disclosed herein. In certain embodiments, it may be desirable to deposit conductive additives and/or a binding agent in conjunction with the cathodically active material as disclosed herein.

In block 650, the second layer may be exposed to an optional compression process. After the particles are deposited over the conductive substrate, the particles may be compressed using compression techniques, for example, a calendaring process, to achieve a desired net density of compacted particles while planarizing the surface of the second layer. In certain embodiments, it is desirable to perform a calendaring process after deposition of the second porous layer in order to increase the packing density of the particles of the second layer relative to the particles of the first layer.

In one embodiment, the first cathodically active material is identical to the second cathodically active material. In one embodiment, the first cathodically active material is a different material than the second cathodically active material.

In one embodiment, the second layer is exposed to a drying process similar to the optional drying processes described for the first layer.

In certain embodiments, the active material spray may include at least one of the following: simultaneous drying during spray, ultrasonic spray of highly viscous slurry, and water-based, low or no solvent slurry.

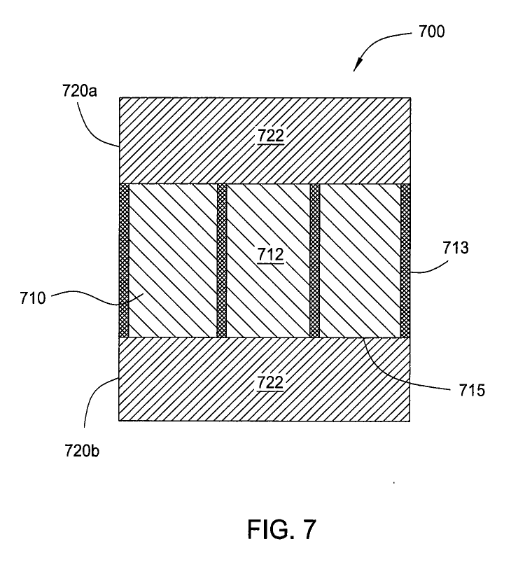

FIG. 7 is a schematic cross-sectional view of one embodiment of a graded cathode electrode 700 formed according to embodiments described herein. The graded cathode electrode 700 is similar to the cathode electrode 103 depicted in FIG. 5C except that the graded cathode electrode 700 is formed using a porous conductive current collector 713 having a plurality of pores 715, the cathodically active particles 712 having a first diameter are deposited within the plurality of pores 715 of the porous conductive current collector 713, and the graded cathode electrode 700 is a two-sided cathode electrode with a shared three-dimensional porous current collector 713. It should be understood that although the graded cathode electrode 700 is depicted as a two-sided electrode, the graded cathode electrode 700 may also be a single sided electrode.

The graded cathode electrode 700 may be formed using processes similar to the method 600 depicted in FIG. 6 except that a first layer 710 having first cathodically active particles 712 having a first diameter is deposited within the pores of the porous conductive substrate 713 using a dual-sided deposition process and second layers 720a, 720b having second cathodically active particles 722 having a second diameter are formed over the first layer 710 on opposing sides of the porous conductive current collector 713 using a dual-sided deposition process, for example, a two-sided spray coating process.

The substrate or current collector 713 may be similar to current collectors 413 and 113. In one embodiment, the substrate or current collector 713 is an aluminum substrate or an aluminum alloy substrate. In one embodiment, the current collector 713 is perforated or porous having a plurality of pores 715.

In one embodiment, the porous current collector 713 is a three dimensional structure having a porosity of from about 50% to about 90%. In one embodiment, the current collector 713 is a three dimensional structure having a porosity of from about 70% to about 85%, for example, about 81%.

As shown in FIG. 7, a first layer 710 having first cathodically active particles 712 having a first diameter is formed within the pores 715 of the porous current collector 713. In one embodiment, the first layer 710 has a thickness between about 50 μm to about 200 μm, for example, about 100 μm. In one embodiment, the particles are nano-scale particles. In one embodiment, the nano-scale particles have a diameter between about 1 nm and about 100 nm. In one embodiment, the particles are micro-scale particles. In one embodiment, the particles of the powder include aggregated micro-scale particles. In one embodiment, the micro-scale particles have a diameter between about 2 μm and about 15 μm. In one embodiment, the first diameter is about 5 μm.

As shown in FIG. 7, second layers 720a, 720b having second cathodically active particles 722 having a second diameter are formed over the first layer 710. In one embodiment, second layers 720a, 720b have a thickness between about 50 μm to about 100 μm. In one embodiment, the particles are nano-scale particles. In one embodiment, the nano-scale particles have a diameter between about 1 nm and about 100 nm. In one embodiment, the particles are micro-scale particles. In one embodiment, the particles of the powder include aggregated micro-scale particles. In one embodiment, the micro-scale particles have a diameter between about 2 μm and about 20 μm. In one embodiment, the second diameter is about 15 μm. In certain embodiments, the second diameter of the cathodically active particles 722 is greater than the first diameter of cathodically active particles 712. In one embodiment, the second diameter is about 15 μm and the first diameter is about 5 μm. In another embodiment, the second diameter is about 5 μm and the first diameter is about 15 μm.

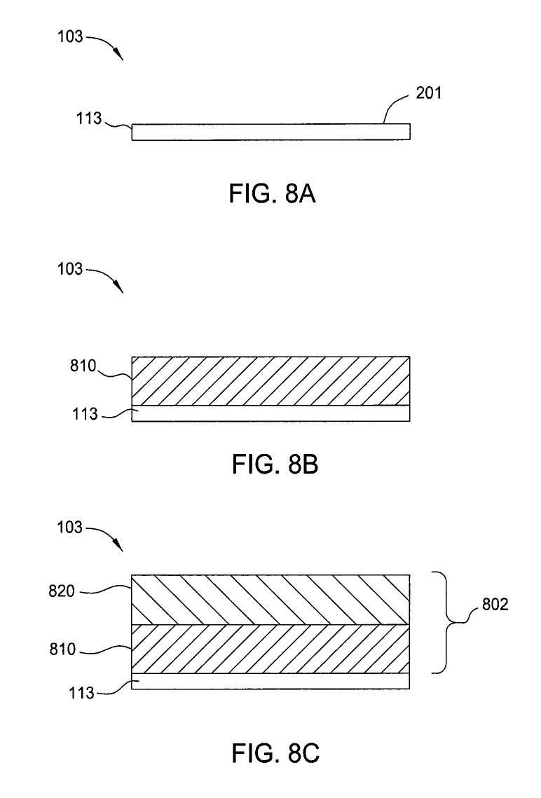

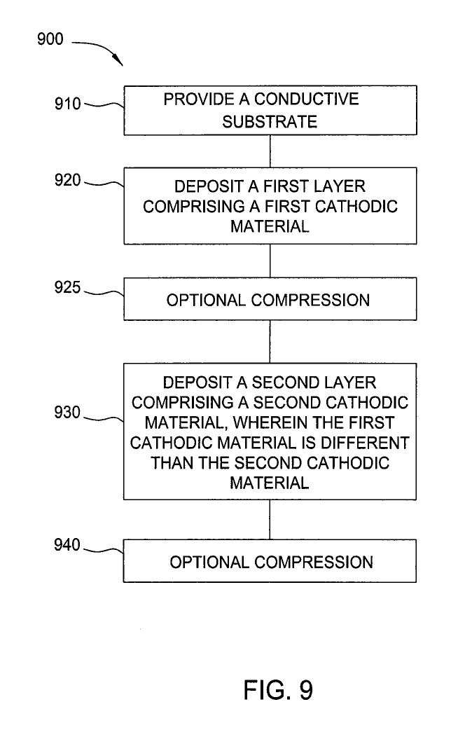

FIGS. 8A-8C are schematic cross-sectional views of one embodiment of a cathode electrode structure 103 formed according to embodiments described herein. FIG. 9 is a process flow chart summarizing one embodiment of a method 900 for forming a cathode electrode structure 103 according to embodiments described herein.

In block 910 a conductive substrate, such as current collector 113 is provided. As shown in FIG. 8A, the current collector 113 is schematically illustrated prior to the deposition of the bi-layer cathode structure 802 on the surface 201 of the current collector 113.

In block 920, a first layer 810 comprising a first cathodically active material is deposited overt the current collector 113. In one embodiment, the first layer 810 has a thickness between about 10 μm to about 150 μm, for example, between about 50 μm to about 100 μm.

In one embodiment, the first cathodically active material is selected from the group comprising: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof. In one embodiment, the first cathodically active material comprises LiFePO₄. As discussed herein, in certain embodiments, it may be desirable to deposit conductive additives and/or a binding agent in conjunction with the cathodically active material.

In block 925, the first layer may be exposed to an optional compression process as described herein to achieve a desired net density of compacted particles while planarizing the surface of the layer.

In block 930, a second layer 820, comprising a second cathodically active material different than the first cathodically active material is deposited over the first layer 810. In one embodiment, the second cathodically active material is selected from the group comprising: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof. In one embodiment, the second cathodically active material comprises LiNixCo₁₋₂ₓMnO₂. As discussed herein, in certain embodiments, it may be desirable to deposit conductive additives and/or a binding agent in conjunction with the cathodically active material.

In one embodiment, the first layer 810 comprises a material that provides for higher power performance with a lower voltage electrode and the second layer 820 comprises a material that provides for a higher voltage electrode with slower power performance. In one embodiment, the first layer 810 comprises LiFePO₄ and the second layer 820 comprises LiNixCo₁₋₂ₓMnO₂.

In block 940, the second layer 820 may be exposed to an optional compression process. After the second cathodically active material is deposited over the conductive substrate, the material may be compressed using compression techniques, for example, a calendaring process, to achieve a desired net density of compacted particles while planarizing the surface of the second layer 820.

The first layer 810 and the second layer 820 may also be exposed to the optional drying processes described herein.

In certain embodiments, the cathode electrode structure 103 may be formed using a laminate process. For example, a first layer is formed on a conductive substrate using embodiments described herein and a second layer comprising a cathodically active material, a binding agent, and a conductive additive is formed on a separate substrate, for example, a glass substrate. The glass substrate is laminated to a top surface of the first layer to form the cathode electrode structure using a compression process and/or heating.

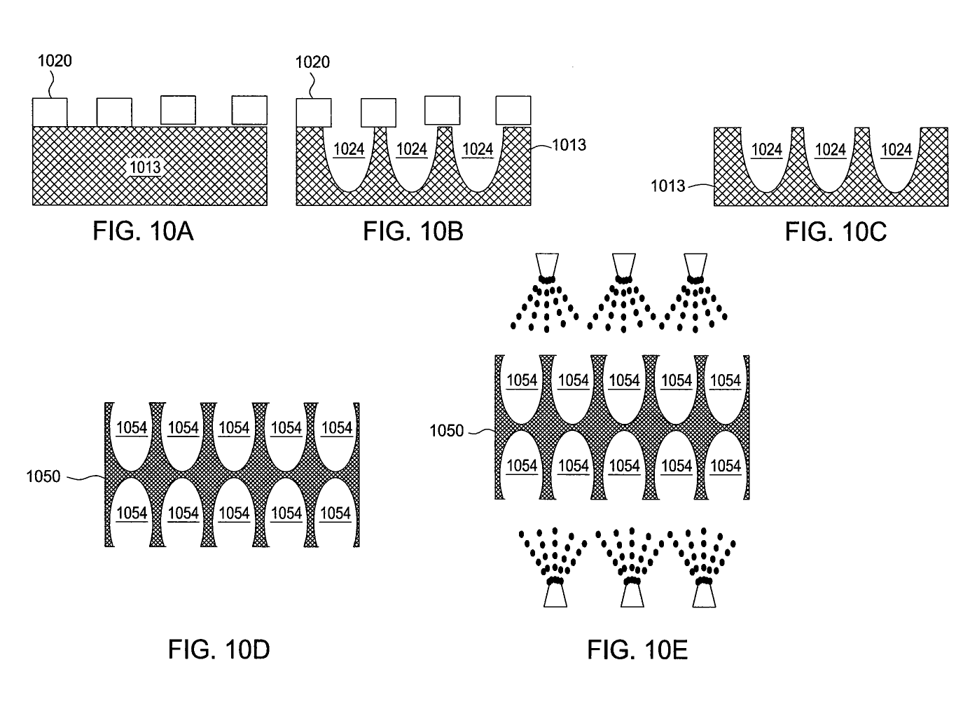

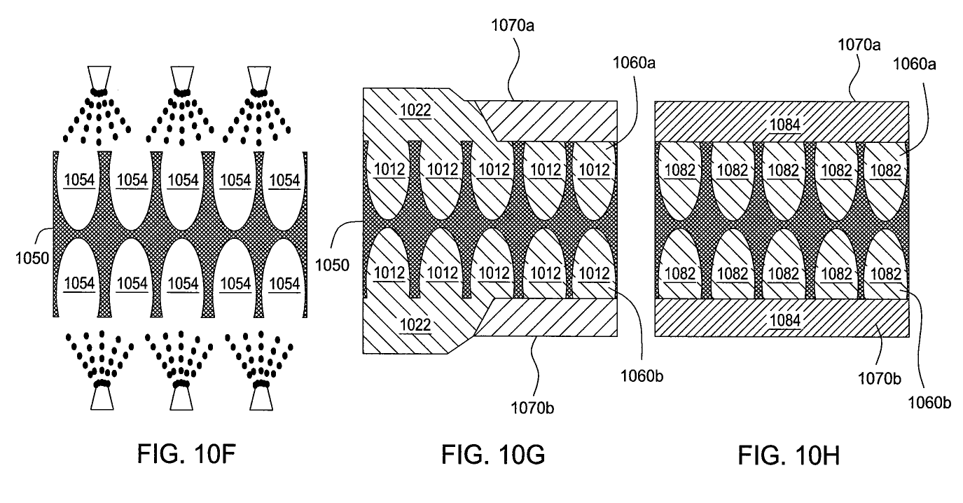

FIGS. 10A-10H are schematic cross-sectional views of one embodiment of a cathode electrode structure formed according to embodiments described herein. FIG. 10A is a schematic view of a conductive substrate 1013 with a photoresist 1020 deposited thereon using an imprint lithography process. FIG. 10B is a schematic view of the conductive substrate 1013 after a wet etching process to form a plurality of pores 1024. FIG. 10C is a schematic view of the conductive substrate 1013 after removal of the photoresist 1020. Although depicted as a one-sided imprint and etching process in FIGS. 10A-10C, it should also be understood that a two-sided imprint and etching process may be performed to form the porous conductive substrate or current collector 1050 depicted in FIGS. 10D-10H. The conductive substrate 1050 is similar to the conductive substrate depicted in FIG. 4B and FIG. 7, however, whereas the plurality of pores 415 depicted in FIGS. 4A and 4B are through-pores which traverse the width of the current collector 413, the plurality of pores 1054 do not traverse the width of the conductive substrate 1050 allowing for the formation of two separate first layers 1060a, 1060b as depicted in FIG. 10G with portions of the conductive substrate 1050 disposed therebetween. In one embodiment, as shown in FIGS. 10E and 10F, the first cathodically active material 1012 which forms first layers 1060a, 1060b and second cathodically active material 1022 which forms second layers 1070a, 1070b may be deposited using separate deposition processes, for example, separate electrostatic spray processes. In one embodiment, the first cathodically active material 1012 which forms first layers 1060a, 1060b and second cathodically active material 1022 which forms second layers 1070a, 1070b are the same cathodically active material with the density of the first layers 1060a, 1060b and second layers 1070a, 1070b modified relative to each other using a compression process.

FIG. 10G is a schematic cross-sectional views of one embodiment of a cathode electrode structure. The graded cathode electrode structure may be formed using processes similar to the process depicted in FIG. 3 except that first porous layers 1060a, 1060b, similar to porous layers 210 and 410 are deposited within the pores of the porous conductive substrate 1050 using a dual-sided deposition process and second porous layers 1070a, 1070b similar to layers 420a, 420b of FIG. 4B are formed on opposing sides of the porous conductive current collector 1050 using a dual-sided deposition process, for example, a two-sided spray coating process. The conductive current collector 1050 may then be exposed to a dual sided compression process to modify the porosity of second porous layers 1070a, 1070b relative to the porosity of the first porous layers 1060a, 1060b as described herein.

The graded cathode electrode depicted in FIG. 10H which is similar to the graded cathode structure 700 depicted in FIG. 7, may be formed using processes similar to those described with reference to FIG. 6 except that separate first layers 1060a, 1060b having first cathodically active particles 1082 having a first diameter are deposited within the pores of the porous conductive substrate 1050 using a dual-sided deposition process and second layers 1070a, 1070b having second cathodically active particles 1084 having a second diameter are formed over the first layers 1060a, 1060b on opposing sides of the porous conductive current collector 1050 using a dual-sided deposition process, for example, a two-sided spray coating process.

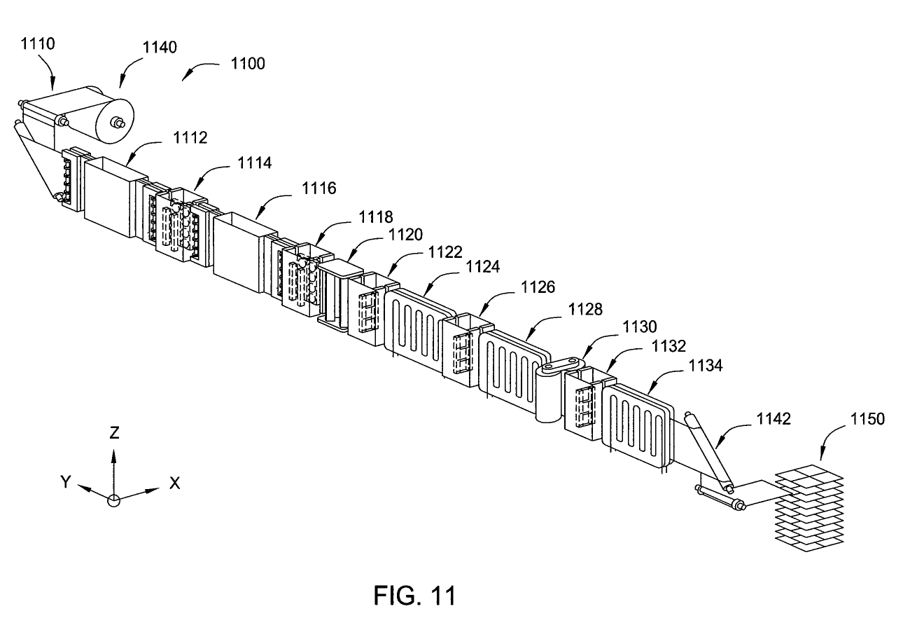

FIG. 11 schematically illustrates one embodiment of a vertical processing system 1100 according to embodiments described herein. The processing system 1100 generally comprises a plurality of processing chambers 1112-1134 arranged in a line, each configured to perform one processing step to a vertically positioned flexible conductive substrate 1110. In one embodiment, the processing chambers 1112-1134 are stand alone modular processing chambers wherein each modular processing chamber is structurally separated from the other modular processing chambers. Therefore, each of the stand alone modular processing chambers, can be arranged, rearranged, replaced, or maintained independently without affecting each other. In one embodiment, the processing chambers 1112-1134 are configured to perform a simultaneous two sided process to simultaneously process each side of the vertically positioned flexible conductive substrate 1110.

In one embodiment, the processing system 1100 comprises an imprint chamber 1112 configured to perform a three dimensional substrate formation process, such as an imprinting process or a punch-through process on at least a portion of the flexible conductive substrate 1110 to form a porous flexible conductive substrate.

In one embodiment, the processing system 1100 further comprises a first rinse chamber 1114 configured to rinse and remove any residual particles and processing solution from the portion of the vertically oriented conductive flexible substrate 1110 with a rinsing fluid, for example, de-ionized water.

In one embodiment, the processing system 1100 further comprises a wet etch chamber 1116 disposed next to the first rinse chamber 1114. In one embodiment, the wet etch chamber 1116 is configured to perform an etching process on at least a portion of the flexible conductive substrate 1110 to increase the porosity of the porous flexible conductive substrate. In one embodiment, chamber 1112 and chamber 1116 may comprise a chamber selected from an imprint chamber, a wet etch chamber, an electrochemical etching chamber, a pattern punch-through chamber, and combinations thereof.

In one embodiment, the processing system 1100 further comprises a second rinse chamber 1118 configured to rinse and remove any residual etching solution from the portion of the vertically oriented conductive flexible substrate 1110 with a rinsing fluid, for example, de-ionized water, after the wet etch process has been performed. In one embodiment, a chamber 1120 comprising an air-knife is positioned adjacent to the second rinse chamber 1118.

In one embodiment, the processing system 1100 further comprises a first drying chamber 1122 disposed adjacent to the air-knife 1120 configured to expose the vertically oriented conductive substrate 1110 to a drying process. In one embodiment, the first drying chamber 1122 is configured to expose the vertically oriented conductive substrate 1110 to a drying process such as an air drying process, for example, exposing the conductive substrate 1110 to heated nitrogen, an infrared drying process, a marangoni drying process, or an annealing process, for example, a rapid thermal annealing process.

In one embodiment, the processing system 1100 further comprises a first spray coating chamber 1124 configured to deposit a cathodically active particles, over and/or into the vertically oriented porous conductive substrate 1110. Although discussed as a spray coating chamber, the first spray coating chamber 1124 may be configured to perform any of the aforementioned deposition processes.

In one embodiment, the processing system 1100 further comprises a drying chamber 1126 disposed adjacent to the first spray coating chamber 1124 configured to expose the vertically oriented conductive substrate 1110 to a drying process, for example, an annealing process. In one embodiment, the drying chamber 1126 is configured to perform a drying process such as a rapid thermal annealing process.

In one embodiment, the processing system 1100 further comprises a second spray coating chamber 1128 positioned adjacent to the drying chamber 1126. Although discussed as a spray coating chamber, the second spray coating chamber 1128 may be configured to perform any of the aforementioned deposition processes. In one embodiment, the second spray coating chamber 1128 is configured to deposit second cathodically active particles over the vertically oriented porous conductive substrate 1110. In one embodiment, the second spray coating chamber 1128 is configured to deposit an additive material such as a binder over the vertically oriented conductive substrate 1110. In embodiments where a two pass spray coating process is used, the first spray coating chamber 1124 may be configured to deposit cathodically active particles over the vertically oriented conductive substrate 1110 during a first pass using, for example, an electrostatic spraying process, and the second spray coating chamber 1128 may be configured to deposit cathodically active particles over the vertically oriented conductive substrate 1110 in a second pass using, for example, a slit coating process.

In one embodiment, the processing system 1100 further comprises a compression chamber 1130 disposed adjacent to the first drying chamber 1122 configured to expose the vertically oriented conductive substrate 1110 to a calendaring process to compress the as-deposited cathodically active particles into the conductive microstructure. In one embodiment, the compression process may be used to modify the porosity of the as-deposited cathodically active particles to a desired net-density.

In one embodiment, the processing system 1100 further comprises a third drying chamber 1132 disposed adjacent to the compression chamber 1130 configured to expose the vertically oriented conductive substrate 1110 to a drying process. In one embodiment, the third drying chamber 1132 is configured to expose the vertically oriented conductive substrate 1110 to a drying process such as an air drying process, for example, exposing the conductive substrate 1110 to heated nitrogen, an infrared drying process, a marangoni drying process, or an annealing process, for example, a rapid thermal annealing process.

In one embodiment, the processing system 1100 further comprises a third spray coating chamber 1134 positioned adjacent to the drying chamber 1132. Although discussed as a spray coating chamber, the third spray coating chamber 1134 may be configured to perform any of the aforementioned deposition processes. In one embodiment, the third spray coating chamber 1134 is configured to deposit a separator layer over the vertically oriented conductive substrate.

In certain embodiments, the processing system 1100 further comprises additional processing chambers. The additional modular processing chambers may comprise one or more processing chambers selected from the group of processing chambers comprising an electrochemical plating chamber, an electroless deposition chamber, a chemical vapor deposition chamber, a plasma enhanced chemical vapor deposition chamber, an atomic layer deposition chamber, a rinse chamber, an anneal chamber, a drying chamber, a spray coating chamber, and combinations thereof. It should also be understood that additional chambers or fewer chambers may be included in the in-line processing system.

The processing chambers 1112-1134 are generally arranged along a line so that portions of the vertically oriented conductive substrate 1110 can be streamlined through each chamber through feed roll 1140 and take up roll 1142. In one embodiment, as the vertically oriented substrate 1110 leaves the take up roll 1142, the substrate 1110 is further processed to form a prismatic assembly 1150.

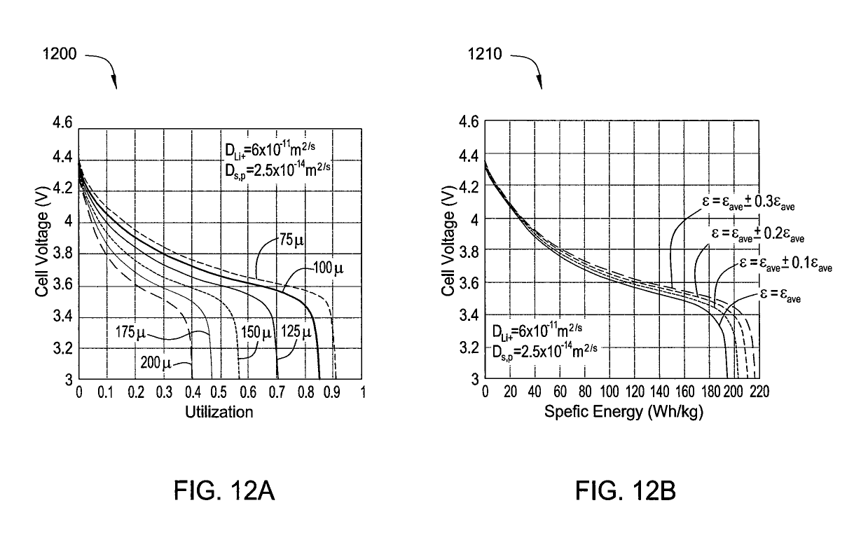

FIG. 12A is a plot 1200 illustrating a simulation demonstrating the effect of electrode thickness on electrode utilization for a NMC/Li cell. The y-axis shows cell voltage (volts) and the x-axis shows the electrode utilization. Electrode thicknesses of 75 microns, 100 microns, 125 microns, 150 microns, 175 microns, and 200 microns are represented. As shown in the plot 1200 an electrode having a thickness of 75 microns has a utilization of 0.9 which means that 90% of the lithium is discharged from the electrode. The plot 1200 further demonstrates that as electrode thickness increases for example, from 75 microns to 200 microns, although an electrode having a thickness of 200 microns can hold more lithium, electrode utilization decreases from 0.9 for the 75 micron electrode to 0.4 for the 200 micron electrode.

FIG. 12B is a plot 1210 illustrating a simulation demonstrating the effect of graded porosity on specific energy in a NMC/Li cell for an electrode having a thickness of 200 microns which is the worst case scenario from FIG. 12A in terms of utilization. The y-axis shows cell voltage (volts) and the x-axis shows the specific energy (Wh/kg). The simulation demonstrates the specific energy for four different scenarios using a 200 micron thick NMC electrode at C rate discharge. The first electrode has a porosity equal to an average porosity (ε=εₐᵥₑ). The second electrode is a dual layer electrode as described herein having a first layer having a porosity that is 10% less than εₐᵥₑ and a second layer having a porosity that is 10% greater than εₐᵥₑ(εₐᵥₑ±0.1εₐᵥₑ). The The third electrode is a dual layer electrode as described herein having a first layer having a porosity that is 20% less than εₐᵥₑ and a second layer having a porosity that is 20% greater than εₐᵥₑ(ε=εₐᵥₑ±0.2εₐᵥₑ). The fourth electrode is a dual layer electrode as described herein having a first layer having a porosity that is 30% less than εₐᵥₑ and a second layer having a porosity that is 30% greater than εₐᵥₑ(ε=εₐᵥₑ±0.3εₐᵥₑ). The plot demonstrates a 12% improvement in specific energy for a 200 micron thick electrode having graded porosity (ε=εₐᵥₑ±0.3εₐᵥₑ) in comparison with a 200 micron electrode having uniform porosity (ε=εₐᵥₑ).

FIG. 13 is a plot 1300 depicting the theoretical energy density for various cathodically active materials that may be used in accordance with the embodiments described herein.

While the foregoing is directed to embodiments of the present invention, other and further embodiments of the invention may be devised without departing from the basic scope thereof, and the scope thereof is determined by the claims that follow.

1. A graded cathode structure, comprising:
a conductive substrate;
a first porous layer comprising a first cathodically active material having a first porosity formed on the conductive substrate; and
a second porous layer comprising a second cathodically active material having a second porosity formed on the first porous layer, wherein the first porosity is less than the second porosity.

2. The graded cathode structure of claim 1, wherein the conductive substrate comprises aluminum.

3. The graded cathode structure of claim 1, wherein the first cathodically active material and the second cathodically active material are individually selected from the group comprising: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof.

4. The graded cathode structure of claim 3, wherein the first cathodically active material has a particle size that is less than a particle size of the second cathodically active material.

5. The graded cathode structure of claim 4, wherein the particle size of the first cathodically active material has a diameter between about 2 μm and about 15 μm and the particle size of the second cathodically active material has a diameter between about 2 μm and about 15 μm.

6. The graded cathode structure of claim 4, wherein the particle size of the first cathodically active material has a diameter between about 1 nm and about 100 nm and the particle size of the second cathodically active material has a diameter between about 1 nm and about 100 nm.

7. The graded cathode structure of claim 4, wherein the first porous layer further comprises a binding agent selected from the group comprising: polyvinylidene difluoride (PVDF), styrene-butadiene rubber (SBR), carboxymethyl cellulose (CMC), and combinations thereof.

8. The graded cathode structure of claim 1, wherein the first porosity is between about 20% and about 35% as compared to a solid film formed from the same material.

9. The graded cathode structure of claim 8, wherein the second porosity is between about 40% and about 70% as compared to a solid film formed from the same material.

10. A method for forming a graded cathode structure, comprising:
providing a conductive substrate;
depositing a first porous layer comprising a first cathodically active material having a first porosity on the conductive substrate; and
depositing a second porous layer comprising a second cathodically active material having a second porosity on the conductive substrate, wherein the second porosity is greater than the first porosity.

11. The method of claim 10, further comprising calendaring the first porous layer to decrease the first porosity to a third porosity.

12. The method of claim 10, wherein the conductive substrate comprises aluminum.

13. The method of claim 10, wherein the first cathodically active material and the second cathodically active material are independently selected from the group comprising: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof.

14. The method of claim 13, wherein depositing a first porous layer further comprises depositing a binding agent selected from the group comprising: polyvinylidene difluoride (PVDF), styrene-butadiene rubber (SBR), carboxymethyl cellulose (CMC), and combinations thereof.

15. The method of claim 10, wherein the first porosity is between about 20% and about 35% as compared to a solid film formed from the same material and the second porosity between about 40% and about 70% as compared to a solid film formed from the same material.

16. The method of claim 11, wherein the first porosity is between about 40% and about 50% as compared to a solid film formed from the same material, the second porosity is between about 40% and about 50% as compared to a solid film formed from the same material, and the third porosity is between about 30% and about 35% as compared to a solid film formed from the same material.

17. The method of claim 10, wherein depositing a first porous layer comprises performing an electrostatic spray process and depositing a second porous layer comprises performing a slit coating process.

18. The method of claim 10, wherein the first cathodically active material comprise particles having a first diameter and the second cathodically active material comprises particles having a second diameter, wherein the second diameter is greater than the first diameter.

19. The method of claim 18, wherein the first diameter is between about 2 μm and about 15 μm and the second diameter is between about 5 μm and about 15 μm.

20. A substrate processing system for processing a vertically oriented flexible conductive substrate, comprising:
a first spray coating chamber configured to deposit cathodically active particles over the vertically oriented flexible conductive substrate;
a drying chamber disposed adjacent the first spray coating chamber configured to expose the vertically oriented flexible conductive substrate to a drying process;
a second spray coating chamber disposed adjacent to the drying chamber configured to deposit cathodically active particles over the vertically oriented flexible conductive substrate;
a compression chamber disposed adjacent to the second spray coating chamber configured to expose the vertically oriented flexible conductive substrate to a calendaring process to compress the deposited particles to a desired net-density; and
a substrate transfer mechanism configured to transfer the vertically oriented flexible conductive substrate among the chambers, wherein each of the chambers comprises:
a processing volume;
a feed roll disposed out side the processing volume and configured to retain a portion of the vertically oriented flexible conductive substrate; and
a take up roll disposed out side the processing volume and configured to retain a portion of the vertically oriented flexible conductive substrate, wherein the substrate transfer mechanism is configured to activate the feed rolls and the take up rolls to move the vertically oriented flexible conductive substrate in and out of each chamber, and hold the one or more flexible conductive substrates in the processing volume of each chamber.
